(19) United States
(12) Patent Application Publication
(10) Pub. No.: US 2025/0192966 A1
(43) Pub. Date: Jun. 12, 2025

(54) CSI-RS TRANSMISSION AND RECEPTION WITH UNIFIED TCI STATES FOR MULTIPLE TRPs

(71) Applicant: Telefonaktiebolaget LM Ericsson (publ), Stockholm (SE)

(72) Inventors: Shiwei Gao, Nepean (CA); Andreas Nilsson, Göteborg (SE); Siva Muruganathan, Stittsville (CA); Jianwei Zhang, Solna (SE)

(21) Appl. No.: 18/843,870

(22) PCT Filed: Mar. 6, 2023
(86) PCT No.: PCT/IB2023/052090

§ 371 Date: Sep. 4, 2024

Related U.S. Application Data
(60) Provisional application No. 63/316,559, filed on Mar. 4, 2022.

(51) Int. Cl. H04L 5/00; H04B 7/06; H04W 72/23

(52) U.S. Cl. CPC H04L 5/0091; H04B 7/0626; H04W 72/23

(57) ABSTRACT

Systems and methods for Channel State Information-Reference Signal (CSI-RS) transmission and reception with unified Transmission Configuration Indication (TCI) states for multiple TRPs are provided. In some embodiments, a method performed by a User Equipment (UE) for determining a unified TCI state includes: receiving a Downlink Control Information (DCI) triggering a CSI-RS resource set; and receiving one or more CSI-RS resources using a unified TCI state based on the DCI. In this way, a simple way to associate a CSI-RS resource to one of multiple activated/indicated unified TCI states (or common beams) for multi-TRP based transmission under unified TCI state framework is provided.

### RELATED APPLICATIONS

This application claims the benefit of provisional patent application Ser. No. 63/316,559, filed Mar. 4, 2022, the disclosure of which is hereby incorporated herein by reference in its entirety.

### TECHNICAL FIELD

The present disclosure relates generally to determining unified Transmission Configuration Indication (TCI) states.

### BACKGROUND

The next generation mobile wireless communication system (5G) or new radio (NR), will support a diverse set of use cases and a diverse set of deployment scenarios. The later includes deployment at both low frequencies (below 6 GHZ) and very high frequencies (up to 10's of GHz).

### NR Frame Structure and Resource Grid

NR uses CP-OFDM (Cyclic Prefix Orthogonal Frequency Division Multiplexing) in both downlink (i.e., from a network node, gNB, or base station, to a user equipment or UE) and uplink (i.e., from UE to gNB). DFT spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically in slot basis, an example is shown in FIG. 1 with a 14-symbol slot, where the first two symbols contain physical downlink control channel (PDCCH) and the rest contains physical shared data channel (PDCH), either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈0, 1, 2, 3, 4. Δf=15 kHz is the basic subcarrier spacing. The slot durations at different subcarrier spacings are given by ½μ ms.

In the frequency domain, a system bandwidth is divided into resource blocks (RBs), each corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

Downlink and uplink transmissions can be either dynamically scheduled in which the gNB transmits a DL assignment or an uplink grant via downlink control information (DCI) over PDCCH (Physical Downlink Control Channel) to a UE for each PDSCH or PUSCH transmission, or semi-persistent scheduled (SPS) in which one or more DL SPS or UL configured grants (CGs) are semi-statically configured and each can be activated or deactivated by a DCI.

CORESET and Search Space

A UE monitors a set of PDCCH candidates for potential PDCCHs. A PDCCH candidate consists of L∈[1, 2, 4, 8, 16] control-channel elements (CCEs) in a Control Resource Set (CORESET). A CCE consists of 6 resource-element groups (REGs) where a REG equals one RB during one OFDM symbol. L is referred to as the CCE aggregation level.

The set of PDCCH candidates is defined in a PDCCH search space (SS) set. A SS set can be a Common Search Space (CSS) set or a UE Specific Search Space (USS) set. A UE can be configured with up to 10 SS sets per bandwidth part (BWP) for monitoring PDCCH candidates.

Each SS set is associated with a CORESET. A CORESET consists of N_{RB}^{CORESET} resource blocks in frequency domain and N_{symb}^{CORESET}∈{1, 2, 3} consecutive OFDM symbols in time domain. In NR Rel-15, a UE can be configured with up to 3 CORESETs per BWP.

### TCI States and QCL

A Transmission Configuration Indication (TCI) state contains Quasi Co-location (QCL) information between two antenna ports. Two antenna ports are said to be QCL if certain channel parameters associated with one of the two antenna ports can be inferred from the other antenna port. An antenna port is defined by a reference signal (RS). Therefore, a TCI state is used in NR to indicate the QCL relation between a source RS and a target RS. The source RS can be one of a Non-zero Power Channel State Information Reference Signal (NZP CSI-RS), tracking RS (TRS), and a Synchronization Signal Block (SSB), while the target RS can be a Demodulation Reference Signal (DMRS) for PDCCH or PDSCH, or a CSI-RS.

The supported QCL information types in NR include:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

A list of TCI states can be RRC configured in a higher layer parameter PDSCH-Config information element (IE) (see 3GPP TS 38.331 section 6.3.2 for details), up to eight TCI states from the list can be activated with a Medium Access Control (MAC) Control Element (CE). In NR Rel-15, one TCI state is activated by a MAC CE for each TCI codepoint of a TCI field in DCI, where up to eight TCI codepoints can be supported (see 3GPP TS 38.321 section 6.1.3.14 for details). In NR Rel-16, up to two TCI states can be activated by a MAC CE for each TCI codepoint (see 3GPP TS38.321 section 6.1.3.24). For dynamically scheduled PDSCH, one of the TCI codepoints is indicated in the TCI field of the DCI (DCI format 1_1 or DCI format 1_2) scheduling the PDSCH for PDSCH reception. For example, if a SSB or CSI-RS is configured as the QCL-typeD source RS in an activated TCI state indicated to a PDSCH, the same receive beam (or spatial filter) for receiving the SSB or CSI-RS would be used by a UE to receive the PDSCH.

For each CORESET, a list of TCI states can be RRC configured, one of the TCI states is activated by a MAC CE. For example, if a SSB is configured as the QCL-typeD source RS in an activated TCI state for a CORESET, the same receive beam for receiving the SSB can be used by a UE to receive PDCCHs transmitted in the CORESET.

Beam Management with Unified TCI Framework

In NR, downlink beam management is performed by conveying spatial QCL (‘Type D’) assumptions to the UE through TCI states.

Such a framework allows great flexibility for the network to instruct the UE to receive signals from different spatial directions in DL with a cost of large signaling overhead and slow beam switch. These limitations are particularly noticeable and costly when UE movement is considered. One example is that beam update using DCI can only be performed for PDSCH, and MAC-CE and/or RRC is required to update the beam for other reference signals/channels, with cause extra overhead and latency.

Furthermore, in majority of cases, the network transmits to and receive from a UE in the same direction for both data and control. Hence, using separate framework (TCI state respective spatial relations) for different channels/signals complicates the implementations.

In Rel-17, a unified TCI state-based beam indication framework was introduced to simplify beam management in FR2, in which a common beam represented by a TCI state may be activated/indicated to a UE and the common beam is applicable for multiple channels/signals such as PDCCH and PDSCH. The common beam framework is also referred to a unified TCI state framework.

The new framework can be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels. A TCI state configured under the newly introduced Rel-17 framework will henceforth be referred to as a unified TCI state.

A unified TCI state for DL or joint DL and UL comprises identifiers of two QCL source reference signals as shown below, where the first RS is a QCL source RS for one of {typeA, typeB, typeC} QCL types, while the second RS is a QCL source RS for QCL typeD. The second RS is used to indicate a spatial beam or filter associated with the unified TCI state.

| | |
|---|---|
| DLorJoint-TCIState-r17 ::= | SEQUENCE { |
| tci-StateUnifiedId-r17 | DLorJoint-TCIState-Id-r17, |
| tci-StateType-r17 | ENUMERATED {DLOnly, JointULDL}, |
| qcl-Type1-r17 | QCL-Info, |
| qcl-Type2-r17 | QCL-Info OPTIONAL -- Need R |

}

| | |
|---|---|
| QCL-Info ::= | SEQUENCE { |

| | |
|---|---|
| cell | ServCellIndex OPTIONAL, -- Need R |

| | |
|---|---|
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...,

A unified TCI state can be updated in a similar way as the TCI state update for PDSCH in Rel-15/16, i.e., with one of two alternatives:
Two-stage: RRC signaling is used to configure a number of unified TCI states in higher layer parameter PDSCH-config, and a MAC-CE is used to activate one of the configured unified TCI states
Three-stage: RRC signaling is used to configure a number of unified TCI states in PDSCH-config, a MAC-CE is used to activate up to eight unified TCI states, and a 3-bit TCI state bitfield in DCI is used to indicate one of the activate unified TCI states

The one activated or indicated unified TCI state will be used in subsequent PDCCH, PDSCH, and NZP CSI-RS transmissions until a new unified TCI state is activated or indicated.

The existing DCI formats 1_1 and 1_2 are reused for beam indication (i.e., TCI state indication/update), both with and without DL assignment. For DCI formats 1_1 and 1_2 with DL assignment, ACK/NACK of the PDSCH can be used as indication of successful reception of beam indication. For DCI formats 1_1 and 1_2 without DL assignment, a new ACK/NACK mechanism analogous to that for SPS PDSCH release with both type-1 and type-2 HARQ-ACK codebook is used, where upon a successful reception of the beam indication DCI, the UE reports an ACK.

For DCI-based beam indication, the first slot to apply the indicated TCI is at least Y symbols after the last symbol of the acknowledgment of the joint or separate DL/UL beam indication. The Y symbols are configured by the gNB based on UE capability, which is also reported in units of symbols.

### Multi-TRP PDCCH Repetition

In NR Rel-17, PDCCH repetition was introduced for more robust PDCCH reception in which a PDCCH is transmitted over two transmission and reception points (TRPs) on different time or frequency resources.

An example is shown in FIG. 3, where a PDCCH is repeated over two TRPs at different times. The 1st PDCCH repetition is sent in a PDCCH candidate in CORESET #c1 associated with SS set #s1 and the second PDCCH repetition is sent in another PDCCH candidate in CORESET #c2 associated with SS set #s2, where SS sets #s1 and #s2 are linked. Each of CORESET #c1 and CORESET #c2 are activated with a transmission configuration indicator (TCI) state associated with the respective TRP.

Two linked SS sets need to be configured with a same set of parameters such as periodicity, slot offset, number of monitoring occasions within a slot, etc. For a given CCE aggregation level and two linked SS sets, the location of one PDCCH candidate in one SS set can be obtained from a PDCCH candidate in the other SS set. When performing PDCCH detection, a UE may detect PDCCH individually in each PDCCH candidate or jointly by soft combining of the two PDCCH candidates.

### SFN PDCCH

In NR Rel-17, single frequency network (SFN) based PDCCH was also introduced for more robust PDCCH reception in which a PDCCH is transmitted simultaneously from two TRPs in a same time and frequency resource. An example is shown in FIG. 4, where a single CORESET and the associated SS set are associated to both TRPs. This is indicated to a UE by both a RRC configuration of SFN PDCCH and a CORESET activated with two TCI states.

Multi-TRP PDSCH schemes

In NR Rel-16, PDSCH transmission over two TRPs was introduced, including a non-coherent joint transmission (NC-JT) scheme, two frequency domain multiplexing (FDM) schemes, and two-time domain multiplexing (TDM) schemes. In these multi-TRP PDSCH schemes, each TRP is represented by an indicated TCI state. In NC-JT, a PDSCH in transmitted over two TRPs in a same time and frequency resource with different MIMO layers of the PDSCH transmitted from different TRPs. For example, 2 layers can be transmitted from a first TRP and 1 layer can be transmitted from a second TRP for a total of 3 layers. For NC-JT based PDSCH scheduling, two TCI states are indicated in a TCI codepoint of DCI scheduling the PDSCH. The DMRS ports in a first and second CDM groups are associated with the first and second TCI states, respectively.

In the FDM schemes, different frequency domain resources of a PDSCH are allocated to different TRPs H. In FDM scheme A, a single PDSCH is transmitted from two TRPs with part of the PDSCH is sent from one TRP and the rest from the other TRP. In FDM scheme B, a

PDSCH is repeated over two TRPs. For FDM based multi-TRP PDSCH scheduling, two TCI states are indicated in a TCI codepoint of DCI scheduling the PDSCH. The DMRS ports in a first and second set of scheduled RBs are associated with the first and second TCI states, respectively.

In the TDM schemes, a PDSCH is repeated in multiple times, each over one of two TRPs. In TDM scheme A, a PDSCH is repeated two times within a slot, one from each TRP. While in TDM scheme B (or slot based TDM scheme), a PDSCH is repeated in consecutive slots, either in a cyclic manner from two TRPs in which the PDSCH is transmitted alternatively from a first TRP in one slot and a second TRP in the next slot, or in a sequential manner in which PDSCH is transmitted alternatively from the first and second TRPs every two consecutive slots. For TDM based multi-TRP PDSCH scheduling, two TCI states are indicated in a TCI codepoint of DCI scheduling the PDSCH. The DMRS ports in a first and second set of PDSCH transmission occasions are associated with the first and second TCI states, respectively. The first and second set of PDSCH transmission occasions are determined according to the mapping type, i.e., cyclic or sequential mapping. An example of TDM Scheme B is shown in FIG. 5, where four PDSCH repetitions are scheduled from two TRPs. In case of cyclic mapping, the 1^{st} and 3^{rd} PDSCH occasions are associated with the 1^{st} TCI state and the 2^{nd} and 4^{th} PDSCH occasions are associated with the 2^{nd} TCI state indicated in the DCI. In case of sequential mapping, the 1^{st} and 2^{nd} PDSCH occasions are associated with the 1^{st} TCI state and the 3^{rd} and 4^{th} PDSCH occasions are associated with the 2^{nd} TCI state indicated in the DCI.

### CSI-RS

Channel State Information Reference Signal, CSI-RS, is used in NR for channel state information, CSI, measurement in the downlink. A CSI-RS is transmitted on an antenna port at the gNB and is used by a UE to measure downlink channel associated with the antenna port. CSI-RS for this purpose is also referred to as Non-Zero Power (NZP) CSI-RS. The antenna port is also referred to as a CSI-RS port. The supported number of CSI-RS ports in a CSI-RS resource in NR can be one of {1, 2, 4, 8, 12, 16, 24, 32}. Multiple CSI-RS resources can be configured. A CSI-RS resource set can contain one or more CSI-RS resources.

A CSI-RS resource can be aperiodic, periodic, or semi-persistent (SP). CSI-RS resources in a CSI-RS resource set are transmitted together and have the same time domain configuration, i.e., aperiodic, periodic or semi-persistent.

Aperiodic CSI-RS transmission is triggered by one of DCI format 0_1 or DCI format 0_2. SP CSI-RS transmission is activated and deactivated by a MAC CE.

In frequency range 2 (FR2), each CSI-RS resource is also associated with a beam which is specified by a QCL source reference signal (RS) with type D. For periodic, the QCL source RS is RRC configured. For Aperiodic CSI-RS, the QCL type D source RS is configured in an associated aperiodic CSI trigger state, where the index of the trigger state is indicated in the DCI triggering the aperiodic CSI-RS. For SP CSI-RS, the QCL source RS is indicated in the corresponding activation MAC CE. These are further explained below.

QCL configuration for aperiodic CSI-RS resources

A “CSI-AperiodicTriggerStateList” information element (IE) defined in 3GPP TS 38.331 is used in NR to configure a UE with a list of aperiodic CSI trigger states, each defined by the parameter “CSI-AperiodicTriggerState”, as shown below. Each codepoint of the “CSI request” field in DCI (DCI format 1_1, or DCI format 1_2) is associated with one of the trigger state in the list, which is described in 3GPP TS38.214 section 5.2.1.5.1. Upon reception of a DCI with a CSI request codepoint indicating a trigger state, the UE receives NZP CSI-RS resources in a NZP CSI-RS resource set indicated by the parameter “resourceset” in the trigger state according the QCL information configured by the parameter “qcl-info”. The QCL information contains a TCI state ID for each NZP CSI-RS resources in the NZP CSI-RS resource set.

CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE (1..maxNrOfCSI-AperiodicTriggers)) |

OF CSI-AperiodicTriggerState

| | |
|---|---|
| CSI-AperiodicTriggerState ::= | SEQUENCE { |

| | |
|---|---|
| associatedReportConfigInfoList | SEQUENCE |

(SIZE(1..maxNrofReportConfigPerAperiodicTrigger)) OF CSI-AssociatedReportConfigInfo,
...
}

| | |
|---|---|
| CSI-AssociatedReportConfigInfo ::= | SEQUENCE { |

| | |
|---|---|
| reportConfigId | CSI-ReportConfigId, |

| | |
|---|---|
| resourcesForChannel | CHOICE { |

| | |
|---|---|
| nzp-CSI-RS | SEQUENCE { |

| | |
|---|---|
| resourceSet | INTEGER (1..maxNrofNZP-CSI-RS- |

ResourceSetsPerConfig),

| | |
|---|---|
| qcl-info | SEQUENCE (SIZE(1..maxNrofAP-CSI-RS- |

ResourcesPerSet)) OF TCI-StateId

OPTIONAL -- Cond Aperiodic

},

| | |
|---|---|
| csi-SSB-ResourceSet | INTEGER (1..maxNrofCSI-SSB-ResourceSetsPerConfig) |

},

| | |
|---|---|
| csi-IM-ResourcesForInterference | INTEGER(1..maxNrofCSI-IM-ResourceSetsPerConfig) |

OPTIONAL, -- Cond CSI-IM-ForInterference
nzp-CSI-RS-ResourcesForInterference INTEGER (1..maxNrofNZP-CSI-RS-

| | |
|---|---|
| ResourceSetsPerConfig) | OPTIONAL, -- Cond NZP-CSI-RS-ForInterference |

...
}
-- TAG-CSI-APERIODICTRIGGERSTATELIST-STOP
-- ASN1STOP

### QCL Information for SP CSI-RS Resources

QCL information for a SP CSI-RS resource in a CSI-RS resource set is indicated in the corresponding MAC CE activating the CSI-RS resource set. The MAC CE is described in TS38.321 section 6.1.3.12 and the format is included in FIG. 6, where a TCI state ID is indicated for each CSi-RS resource in the SP CSI-RS resource set. Where the meaning of each field is as follows:
A/D: This field indicates whether to activate or deactivate indicated SP CSI-RS and CSI-IM resource set(s). The field is set to 1 to indicate activation, otherwise it indicates deactivation;
Serving Cell ID: This field indicates the identity of the Serving Cell for which the MAC CE applies. The length of the field is 5 bits;
BWP ID: This field indicates a DL BWP for which the MAC CE applies as the codepoint of the DCI bandwidth part indicator field as specified in TS 38.212. The length of the BWP ID field is 2 bits;
SP CSI-RS resource set ID: This field contains an index of NZP-CSI-RS-ResourceSet containing Semi Persistent NZP CSI-RS resources, as specified in TS 38.331, indicating the Semi Persistent NZP CSI-RS resource set, which shall be activated or deactivated. The length of the field is 6 bits;
IM: This field indicates the presence of the octet containing SP CSI-IM resource set ID field. If the IM field is set to 1, the octet containing SP CSI-IM resource set ID field is present. If IM field is set to 0, the octet containing SP CSI-IM resource set ID field is not present;
SP CSI-IM resource set ID: This field contains an index of CSI-IM-ResourceSet containing Semi Persistent CSI-IM resources, as specified in TS 38.331 [5], indicating the Semi Persistent CSI-IM resource set, which shall be activated or deactivated. The length of the field is 6 bits;
TCI State IDᵢ: This field contains TCI-StateId, as specified in TS 38.331, of a TCI State, which is used as QCL source for the resource within the Semi Persistent NZP CSI-RS resource set indicated by SP CSI-RS resource set ID field. TCI State ID₀ indicates TCI State for the first resource within the set, TCI State ID₁ for the second one and so on. The length of the field is 7 bits. If the A/D field is set to 0, the octets containing TCI State ID field(s) are not present;
R: Reserved bit, set to 0.

For a periodic NZP CSI-RS resource, the QCL information is configured in the NZP CSI-RS resource as shown below by the parameter “qcl-InfoPeriodicCSI-RS”:

NZP-CSI-RS-Resource information element

-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| scramblingID | ScramblingId, | |
|---|---|---|
| periodicityAndOffset | CSI-ResourcePeriodicityAndOffset | OPTIONAL, -- |

Cond PeriodicOrSemiPersistent

| | | |
|---|---|---|
| qcl-InfoPeriodicCSI-RS | TCI-StateId | OPTIONAL, -- Cond |

Periodic
...
}
-- TAG-NZP-CSI-RS-RESOURCE-STOP
-- ASN1STOP

Improved systems and methods for determining unified TCI states are needed.

### SUMMARY

Systems and methods for Channel State Information-Reference Signal (CSI-RS) transmission and reception with unified Transmission Configuration Indication (TCI) states for multiple TRPs are provided. In some embodiments, a method performed by a User Equipment (UE) for determining a unified TCI state includes: receiving a Downlink Control Information (DCI) triggering a CSI-RS resource set; and receiving one or more CSI-RS resources using a unified TCI state based on the DCI. In this way, a simple way to associate a CSI-RS resource to one of multiple activated/indicated unified TCI states (or common beams) for multi-TRP based transmission under unified TCI state framework is provided.

Certain aspects of the disclosure and their embodiments may provide solutions to these or other challenges. Implicit association of a CSI-RS resource to one of two, a first and second, activated/indicated unified TCI states:

If a single AP CSI-RS resource is contained in a NZP CSI-RS resource set triggered by a DCI: If the DCI is carried by a PDCCH in a CORESET associated with a SS set which is not linked to any other SS set, the unified TCI state (or common beam) used to receive the PDCCH is used for receiving the AP CSI-RS resource. If the DCI is carried by a PDCCH repeated in two CORESETs each associated with one of two linked SS sets, the unified TCI state (or common beam) used to receive the PDCCH in one of the two CORESETs is used for receiving the AP CSI-RS. The one of two CORESETs can be the CORESET associated with one of the two SS sets having a lower SS set index among the two SS sets. If the DCI is carried by a SFN PDCCH in a CORESET associated with two unified TCI states (or common beams), one of the unified TCI states (or common beams), either the first or second unified TCI state, is used for receiving the AP CSI-RS.

If two AP CSI-RS resources or groups of AP CSI-RS resources are in a CSI-RS resource set triggered by a DCI, the first and second AP CSI-RS resources or groups of AP CSI-RS resources are associated with the first and second unified TCI states (or common beams), respectively, where the first and second CSI-RS resources are according to the order configured in the CSI-RS resource set. If a single SP CSI-RS resource in a NZP CSI-RS resource set is activated by a MAC CE: If the MAC CE is carried by a PDSCH received with a single unified TCI state (or common beam), the unified TCI sate (or common beam) is also used for receiving the SP CSI-RS resource. If the MAC CE is carried by a PDSCH received with both a first and second, unified TCI states (or common beams) at either the same or different times, one of the two unified TCI states (or common beams) is also used for receiving the SP CSI-RS.

If two SP CSI-RS resources or two groups of SP CSI-RS resources are in a NZP CSI-RS resource set activated by a MAC CE, the first and second SP CSI-RS resources or groups of SP CSI-RS resources are associated with the first and second unified TCI state (or common beams), respectively, where the first and second CSI-RS resources are according to the order configured in the CSI-RS resource set. If more than two AP or SP CSI-RS resources in a CSI-RS resource set are triggered by a DCI or activated by a MAC CE, the CSI-RS resources are received according to the QCL information configured or indicated for each of the CSI-RS resources in the corresponding aperiodic CSI trigger state or activation MAC CE.

Explicit configuration of a unified TCI state pointer for each NZP CSI-RS resource. For AP CSI-RS, a unified TCI state pointer may be configured in the associated aperiodic CSI trigger state for the associated CSI-RS resource set or for each NZP CSI-RS resource in the CSI-RS resource set. For SP CSI-RS, a unified TCI state pointer may be indicated in the activating MAC CE for each SP CSI-RS resource. For periodic CSI-RS, a unified TCI state pointer may be configured in each periodic NZP CSI-RS resource.

A method of associating a NZP CSI-RS resource to one of a first and second unified TCI states that have been activated and indicated to a UE. The association can be either implicit or explicit or a mixture of both.

In case of implicit association, the NZP CSI-RS resource is associated with a unified TCI state of the corresponding PDCCH triggering the NZP CSI-RS or of the PDSCH carrying the corresponding MAC CE for activating the NZP CSI-RS resource.

If the PDCCH or PDSCH is associated with two unified TCI states, and triggered or activated NZP CSI-RS resource set contains one NZP CSI-RS resource, the NZP CSI-RS resource is associated with the first or second of the two unified TCI states.

If a NZP CSI-RS resource set contains two NZP CSI-RS resources or two groups of NZP CSI-RS resources, the first and second NZP CSI-RS resources or groups of NZP CSI-RS resources are associated with the first and second unified TCI states, respectively.

If a NZP CSI-RS resource set contains more than two NZP CSI-RS resources, a TCI state pointer is configured for each of the NZP CSI-RS resources in an associated aperiodic CSI trigger state or activation MAC CE

In case of explicit association, a TCI state pointer is configured for each NZP CSI-RS resource in either an associated aperiodic CSI trigger state for AP CSI-RS, an activation MAC CE for SP CSI-RS, or directly in the NZP CSI-RS resource or resource set for either AP/SP/periodic NZP CSI-RS, where the TCI state pointer points to one of the first or second activated/indicated unified TCI states.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates data scheduling in New Radio (NR) is typically in slot basis with a 14-symbol slot, where the first two symbols contain physical downlink control channel (PDCCH) and the rest contains physical shared data channel (PDCH), either physical downlink shared channel (PDSCH) or physical uplink shared channel (PUSCH);

FIG. 2 illustrates the basic NR physical time-frequency resource grid with only one resource block (RB) within a 14-symbol slot;

FIG. 3 illustrates a PDCCH is repeated over two transmission and reception points (TRPs) at different times;

FIG. 4 illustrates a single Control Resource Set (CORESET) and the associated search space (SS) set are associated to both TRPs;

FIG. 5 illustrates an example of time domain multiplexing (TDM) Scheme B where four PDSCH repetitions are scheduled from two TRPs;

FIG. 6 illustrates the Medium Access Control (MAC) Control Element (CE) is described in TS38.321 section 6.1.3.12, where a TCI state ID is indicated for each Channel State Information Reference Signal (CSI-RS) resource in the semi-persistent (SP) CSI-RS resource set;

FIG. 7 shows an example of CSI-RS transmission under unified TCI state framework for downlink (DL) multi-TRP transmissions from two TRPs, TRP1 and TRP2, where two unified TCI sates are activated and indicated, according to some embodiments of the current disclosure;

FIG. 8 shows an example of a communication system in accordance with some embodiments;

FIG. 9 shows a User Equipment (UE) in accordance with some embodiments;

FIG. 10 shows a network node in accordance with some embodiments;

FIG. 11 is a block diagram of a host, which may be an embodiment of the host of FIG. 8, in accordance with various aspects described herein;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

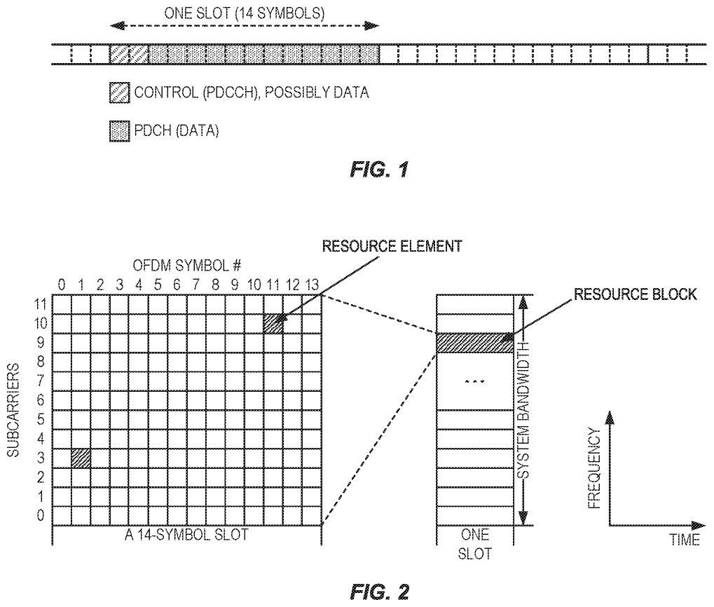

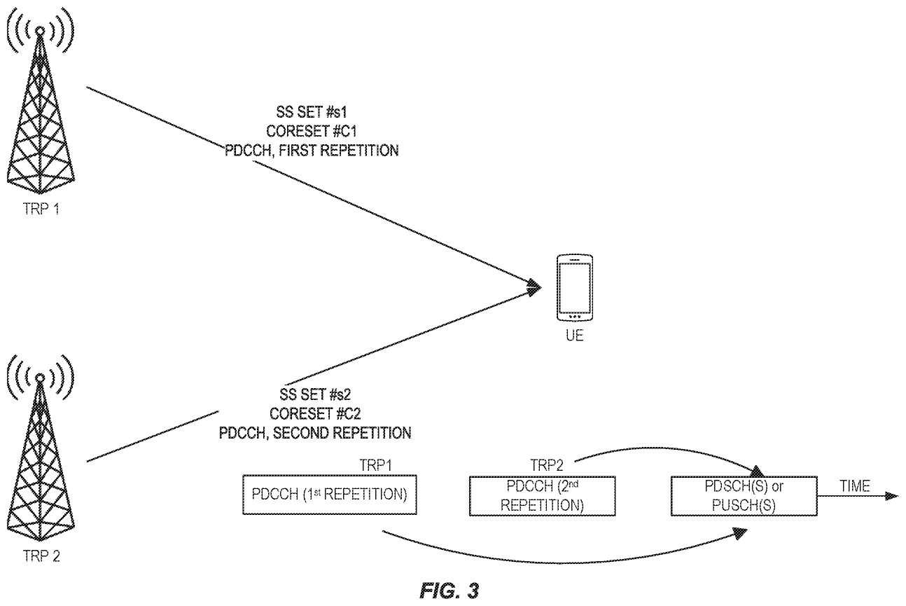

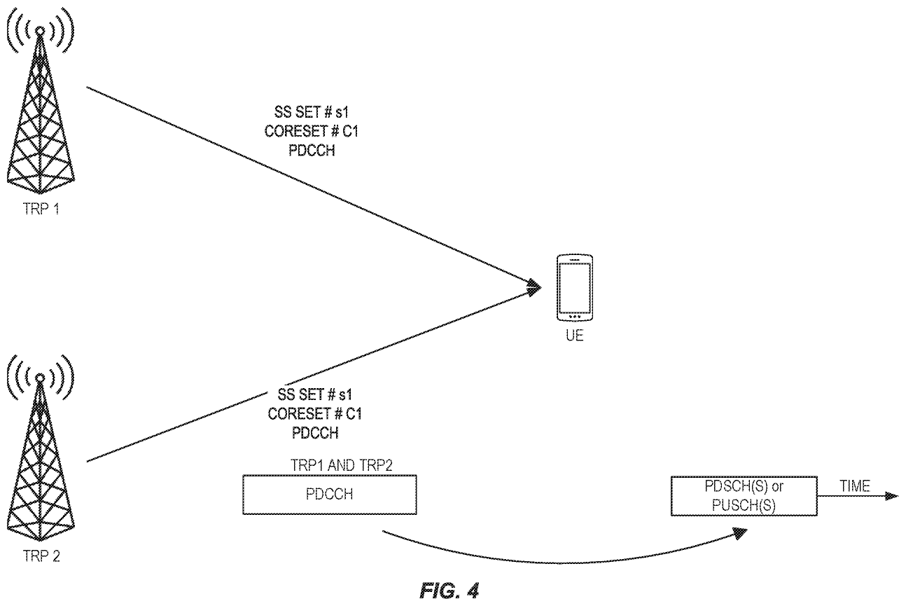

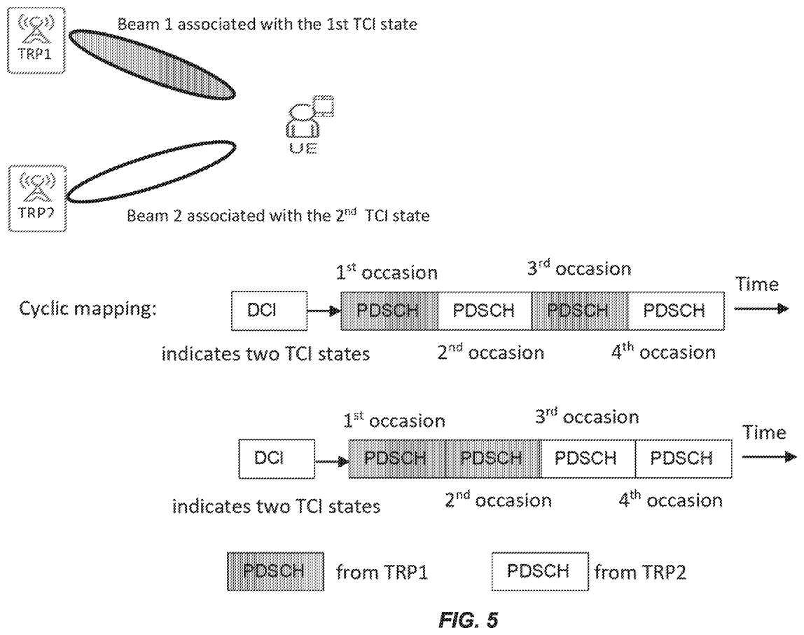

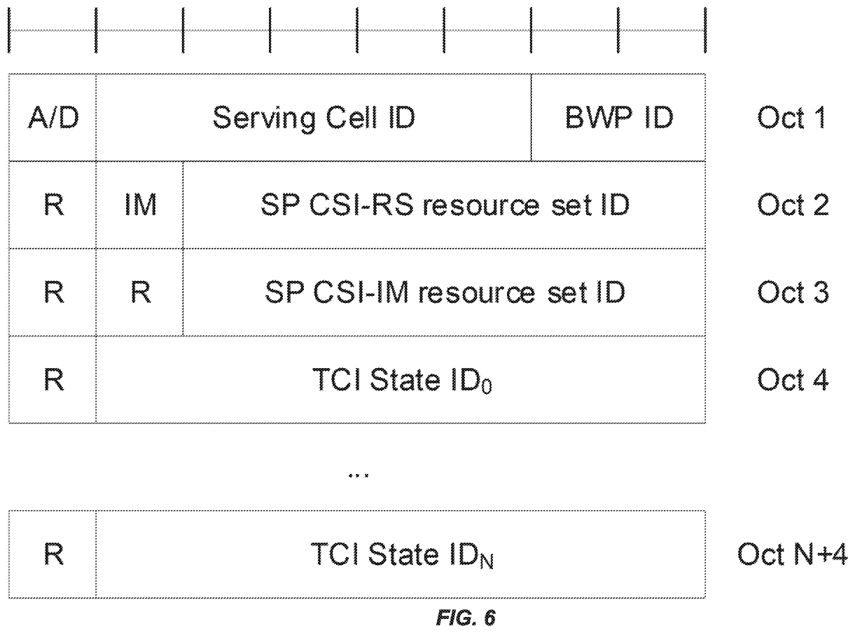

### DETAILED DESCRIPTION

There currently exist certain challenge(s). In the unified TCI state framework introduced in NR Rel-17, only a single unified TCI state can be activated or indicated at any time. Thus, it is only applicable to data transmissions from a single TRP. However, PDSCH transmission from multiple TRPs (or multi-TRP, or mTRP) are already supported in NR Rel-16, PDCCH transmission from multiple TRPs is further supported in NR Rel-17. The mTRP PDSCH and PDCCH schemes supported in Rel-16 and Rel-17 are not supported by the unified TCI framework introduced in Rel-17, they rely on the Rel-15 TCI state/spatial relation framework.

It has been decided in 3GPP that the unified TCI state framework will be extended to support mTRP schemes in NR Rel-18. To support mTRP PDSCH and PDCCH schemes, multiple unified TCI states need to be activated/indicated to the UE. How to associate a CSI-RS transmission to one or more of the multiple unified TCI states is a problem.

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

It is envisioned that when unified TCI state framework is configured to support DL transmissions from multiple TRPs in a DL BWP of a serving cell, multiple unified TCI sates, one associated to each TRP, need to be activated/indicated for a UE via a combination of RRC, MAC CE and DCI signaling, where a list of unified TCI sates is configured by RRC, a subset of the unified TCI states are activated for each TCI codepoint by a MAC CE, and one TCI codepoint is indicated by a DCI format (e.g., DCI format 1_1 or DCI format 1_2). The unified TCI states would be used for subsequent DL transmissions for all or a subset of channels or signals to the UE, including PDCCH, PDSCH and CSI-RS, in the BWP of the serving cell.

In the following, unified TCI states associated with the indicated TCI codepoint in DCI are referred to as activated/indicated unified TCI states. The terms of activated/indicated unified TCI states, activated unified TCI states, indicated unified TCI states, indicated TCI states, and common beams are used interchangeably. Also, the terms of CSI-RS and NZP CSI-RS are used interchangeably.

Embodiments related to implicit association between CSI-RS and activated/indicated unified TCI state

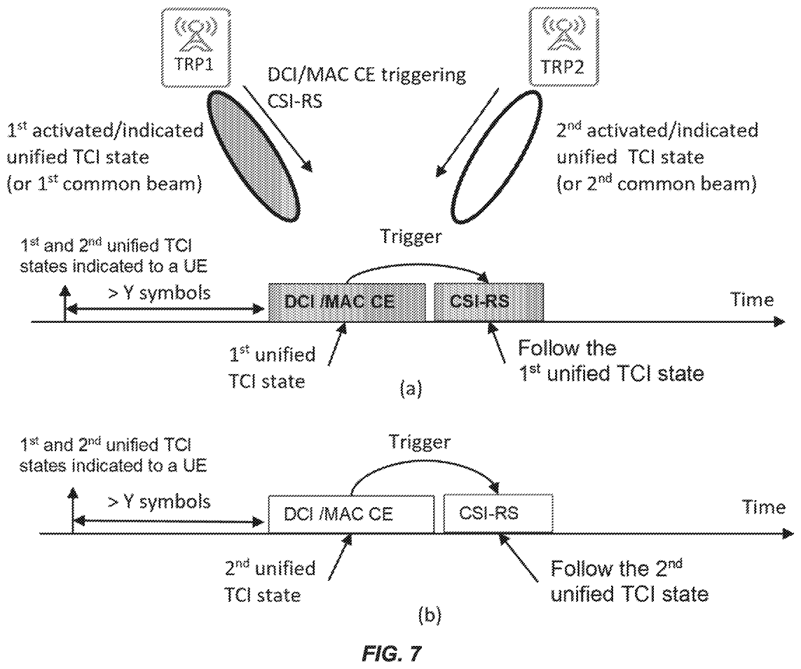

FIG. 7 shows an example of CSI-RS transmission under unified TCI state framework for DL multi-TRP transmissions from two TRPs, TRP1 and TRP2, where two unified TCI sates are activated and indicated. An aperiodic CSI-RS resource set may be triggered by a DCI or a SP CSI-RS resource set may be activated by a MAC

### Aperiodic CSI-RS

For each aperiodic CSI-RS resource in a CSI-RS resource set triggered by a DCI format, it would be transmitted according to one of the two indicated unified TCI sates, or in other words, associated with one of the first and second indicated unified TCI states.

In one embodiment, if a CSI-RS resource set with a single CSI-RS resource is triggered by a DCI format and the DCI format is transmitted in one of the two common beams or associated with one of the two indicated unified TCI states, the CSI-RS resource is transmitted in the same common beam as that of the corresponding triggering DCI. In other words, the CSI-RS resource is associated with a same activated/indicated unified TCI state as that of the PDCCH carrying the triggering DCI in a same BWP. This is illustrated in FIG. 7. If the CSI-RS overlaps with another DL channel or signal, the unified TCI state of the other DL channel or signal would be used for the CSI-RS.

In case that the PDCCH carrying the triggering DCI is associated with two unified TCI states, i.e., the PDCCH is either repeated in two CORESETs each activated with one of the two unified TCI states (or is repeated from two TRPs) or is transmitted in a CORESET activated with the two unified TCI states (i.e., is transmitted in a SFN manner from the two TRPs), in one embodiment, the triggered CSI-RS resource is always associated the first (or second) activated/indicated unified TCI state. In another embodiment, if the time offset between the start of the CSI-RS and the end of the PDCCH (in case of PDCCH repetition with two PDCCH candidates, the end of the PDCH is the end of the PDCCH candidate ended later in time) is greater than a predefined threshold, the associated one of the first and second activated/indicated TCI states is indicated in the DCI or is indicated in one of the CSI-RS resource, the CSI-RS resource set, or aperiodic CSI triggering states. In another embodiment, the CSI-RS resource is associated with one of the two activated/indicated TCI states

If two AP CSI-RS resources in a CSI-RS resource set are triggered by a DCI, the first and second AP CSI-RS resources are associated with the first and second unified TCI states, respectively, where the first and second CSI-RS resources are according to the order configured in the CSI-RS resource set. In another embodiment, two AP CSI-RS resources in a CSI-RS resource set may be configured in two resource groups (e.g., two channel measurement resource (CMR) groups) where the first AP CSI-RS resource belongs to the first resource group and the second AP CSI-RS resource belongs to the second resource group. In this case, the first AP CSI-RS resource belonging to the first resource group is associated with the first unified TCI state, and the second AP CSI-RS resource belonging to the second resource group is associated with the second unified TCI state.

If the triggered CSI-RS resource set contains more than two CSI-RS resources, in one embodiment, the QCL information configured in the aperiodic CSI trigger state is used for receiving the CSI-RS resources in the CSI-RS resource set, where the configured QCL source RS may be different from that in the indicated unified TCI states.

In an alternative embodiment, when more than two CSI-RS resources are configured in a triggered CSI-RS resource set, these more than two CSI-RS resources within the triggered CSI-RS set are configured to belong to two resource groups (i.e., a first subset of AP CSI-RS resources belong to the first resource group and a second subset of AP CSI-RS resources belong to the second resource group where the two subsets are mutually exclusive sets). Then, the first subset of AP CSI-RS resources belonging to the first resource group are associated with the first unified TCI state. The second subset of AP CSI-RS resource belonging to the second resource group are associated with the second unified TCI state.

### SP CSI-RS

For each SP CSI-RS resource in a CSI-RS resource set activated by a MAC CE, the SP CSI-RS would be transmitted with one of the two activated/indicated unified TCI states (or common beams).

In one embodiment, if a SP CSI-RS resource set with a single SP CSI-RS resource is activated by a MAC CE and the PDSCH carrying the MAC CE is received using a single activated/indicated unified TCI state (or common beam), the CSI-RS resource is received using the same activated/indicated unified TCI state (or common beam) as the corresponding PDSCH. In other words, the SP CSI-RS resource is associated with a same TCI state as the PDSCH carrying the activation MAC CE. This is illustrated in FIG. 7.

In case that the PDSCH carrying the activation, MAC CE is associated with two TCI states, i.e., the PDSCH is one of the mTRP schemes, in one embodiment, the activated SP CSI-RS resource is always associated with the first (or second) activated/indicated unified TCI state. Note that mTRP schemes here refer to any one of the following:
a PDSCH reception scheme where a first subset of PDSCH layers is received using the first activated/indicated unified TCI state, and a second subset of PDSCH layers are received using the second activated/indicated unified TCI state, wherein the first subset of PDSCH layers and the second subset of PDSCH layers are mutually exclusive sets. This scheme is known as non-coherent joint transmission (NC-JT) scheme.
a PDSCH repetition scheme involving multiple PDSCH transmission occasions where a first subset of PDSCH transmission occasions is received using the first activated/indicated unified TCI state, and a second subset of PDSCH transmission occasions is received using the second activated/indicated unified TCI state; note that the different PDSCH transmission occasions can be in either frequency domain or time domain (e.g., frequency domain repetitions or time-domain repetitions).

In another embodiment, the associated one of the first and second TCI states is indicated in the DCI or in one of the CSI-RS resources, the CSI-RS resource set, or aperiodic CSI triggering state.

If two SP CSI-RS resources in a SP CSI-RS resource set are activated by a MAC CE, the first and second SP CSI-RS resource are associated with the first and second common beams, respectively, where the first and second CSI-RS resources are according to the order configured in the SP CSI-RS resource set. In another embodiment, two SP CSI-RS resources in a CSI-RS resource set may be configured in two resource groups (or channel measurement resource groups) where the first SP CSI-RS resource belongs to the first resource group and the second SP CSI-RS resource belongs to the second resource group. In this case, the first SP CSI-RS resource belonging to the first resource group is associated with the first unified TCI state, and the second SP CSI-RS resource belonging to the second resource group is associated with the second unified TCI state.

If the SP CSI-RS resource set contains multiple CSI-RS resources (i.e., more than 2 CSI-RS resources), the CSI-RS resources are received according to the QCL information indicated for each of the CSI-RS resources in the corresponding activation MAC CE, where the indicated QCL source RS in the MAC CE may be different from that in the indicated unified TCI states

In an alternative embodiment, when more than two CSI-RS resources are configured in a triggered CSI-RS resource set, these more than two CSI-RS resources within the triggered CSI-RS set are configured to belong to two resource groups (i.e., a first subset of SP CSI-RS resources belonging to the first resource group and a second subset of SP CSI-RS resources belonging to the second resource group where the two subsets are mutually exclusive sets). Then, the first subset of SP CSI-RS resources belonging to the first resource group are associated with the first unified TCI state. The second subset of SP CSI-RS resources belonging to the second resource group are associated with the second unified TCI state.

Embodiments related to explicit association between a NZP CSI-RS resource and one of the indicated unified TCI states

Instead of implicitly associating a NZP CSI-RS resource to one of the activated/indicated unified TCI states based on the triggering PDCCH for aperiodic CSI-RS resources or the PDSCH carrying the activation MAC CE for SP NZP CSI-RS resources, a TCI state pointer (or a common beam index) is explicitly configured for the NZP CSI-RS resource.

For example, if up to three unified TCI states are activated for each TCI codepoint by a MAC CE as shown below, where TCI states in each row are associated with a same TCI state pointer. For example, TCI states in the first row are associated to TCI state pointer=1, TCI states in the second row are associated to TCI state pointer=2, TCI states in the last row are associated to TCI state pointer=3. Thus, if TCI codepoint 3 is indicated in a DCI, three unified TCI states {x3, y3, z3} would be indicated. In this case, if a NZP CSI-RS resource is configured with TCI state pointer=1, the NZP CSI-RS resource would be transmitted/received according to TCI state x3. Next time if TCI codepoint 5 is indicated in a DCI, three new unified TCI states {x5, y5, z5} would be indicated and the NZP CSI-RS resource would be transmitted/received according to TCI state x5. In this way, the NZP CSI-RS resource is associated with one of the activated/indicated unified TCI states (or common beams) while the actual TCI state (or actual beam) can be different at different times due to, for example, beam changes for tracking a UE movement. The indicated unified TCI states can be either unified DL and UL TCI states or DL only TCI states for a BWP, a serving cell, or a list of serving cells in which the NZP CSI-RS is transmitted.

The following table is an example of associating activated unified TCI states for a TCI codepoint to TCI state pointers:

| | TCI code point | | | | | | | |
|---|---|---|---|---|---|---|---|---|
| | 0 | 1 | 2 | 3 | 4 | 5 | 6 | 7 |
| TCI state | TCI | TCI | TCI | TCI | TCI | TCI | TCI | TCI |
| Pointer = 1 | state | state | state | state | state | state | state | state |
| | x0 | x1 | x2 | x3 | x4 | x5 | x6 | x7 |
| TCI state | TCI | TCI | TCI | TCI | TCI | TCI | TCI | TCI |
| Pointer = 2 | state | state | state | state | state | state | state | state |
| | y0 | y1 | y2 | y3 | y4 | y5 | y6 | y7 |
| TCI state | TCI | TCI | TCI | TCI | TCI | TCI | TCI | TCI |
| Pointer = 3 | state | state | state | state | state | state | state | state |
| | z0 | z1 | z2 | z3 | z4 | z5 | z6 | z7 |

In one embodiment, a TCI state pointer is configured in each NZP CSI-RS resource to indicate the unified TCI state to be used for transmitting/reception of the CSI-RS resource when a set of unified TCI states are activated/indicated. An example is shown below, where the parameter “unified-tci-State-Pointer” is a new parameter used to select one of multiple activated/indicated unified TCI states for the NZP CSI-RS resource and “maxNrofIndicated-TCI-States” is the maximum number of unified TCI states can be activated for a TCI codepoint. By doing so, there is no need to use MAC CE to activate a TCI state for a SP CSI-RS resource. For a periodic NZP CSI-RS resource, the legacy parameter qcl-InfoPeriodicCSI-RS is ignored if “unified-tci-State-Pointer” is configured for the CSI-RS resource.

NZP-CSI-RS-Resource information element

-- ASN1START
-- TAG-NZP-CSI-RS-RESOURCE-START

| NZP-CSI-RS-Resource ::= | | SEQUENCE { |
|---|---|---|
| nzp-CSI-RS-ResourceId | | NZP-CSI-RS-ResourceId, |
| resourceMapping | | CSI-RS-ResourceMapping, |
| powerControlOffset | | INTEGER (−8..15), |
| powerControlOffsetSS | | ENUMERATED{db−3, db0, |
| db3, db6} | OPTIONAL, | -- Need R |

| | |
|---|---|
| scramblingID | ScramblingId, |
| periodicityAndOffset | CSI- |
| ResourcePeriodicityAndOffset | OPTIONAL, -- Cond |

PeriodicOrSemiPersistent

| | |
|---|---|
| qcl-InfoPeriodicCSI-RS | TCI-StateId |

OPTIONAL, -- Cond Periodic

| | |
|---|---|
| unified-tci-State-Pointer = | INTEGER |

(1..maxNrofIndicated-TCI-States)
...
}
-- TAG-NZP-CSI-RS-RESOURCE-STOP
-- ASN1STOP

Alternatively, the TCI state pointer is configured in each NZP CSI-RS resource set to indicate the unified TCI state to be used for transmitting/reception of all NZP CSI-RS resources in the CSI-RS resource set as shown below.

NZP-CSI-RS-ResourceSet information element

| -- ASN1START | |
|---|---|
| -- TAG-NZP-CSI-RS-RESOURCESET-START | |
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |
| (1..maxNrofNZP-CSI-RS-ResourcesPerSet) ) OF NZP-CSI-RS-ResourceId, | |
| OPTIONAL, -- Need S | |
| aperiodicTriggeringOffset | INTEGER(0..6) |
| OPTIONAL, -- Need S | |
| OPTIONAL, -- Need R | |
| ..., | |
| [[ | |
| aperiodicTriggeringOffset-r16 | INTEGER(0..31) |
| OPTIONAL -- Need S | |
| ]] | |
| Unified-tci-State-Pointer = | INTEGER |

(1..maxNrofIndicated-TCI-States)
}
-- TAG-NZP-CSI-RS-RESOURCESET-STOP
-- ASN1STOP

For aperiodic NZP CSI-RS resources, in one alternative embodiment, a TCI state pointer is explicitly configured in the corresponding aperiodic CSI trigger state as illustrated below. In this case, if the UE is triggered with an aperiodic CSI trigger state, the UE should assume that the QCL assumption for all NZP CSI-RS resources associated with this aperiodic CSI trigger state should be received with the TCI state associated with the TCI state pointer configured. Note that an aperiodic CSI trigger state may contain multiple CSI report configurations each having an associated NZP CSI-RS resource set for channel measurement. This embodiment means that the configure TCI state pointer is applicable for NZP CSI-RS resources in all the associated NZP CSI-RS resource sets. An example of configuring a TCI state pointer (or a common beam index) for all CSI-RS resource sets associated with an aperiodic CSI trigger state is below.

```
CSI-AperiodicTriggerStateList ::= SEQUENCE (SIZE
(1..maxNrOfCSI-AperiodicTriggers)) OF CSI-AperiodicTriggerState
CSI-AperiodicTriggerState ::= SEQUENCE {
  associatedReportConfigInfoList SEQUENCE
(SIZE(1..maxNrofReportConfigPerAperiodicTrigger)) OF
CSI-AssociatedReportConfigInfo,
  ...
[[
unified-tci-State-Pointer INTEGER (1..maxNrofIndicated-TCI-States)
]]
}
```

In another embodiment, the TCI state pointer is explicitly configured per “CSI-AssociatedReportConfigInfo” as schematically illustrated below, i.e., the TCI state pointer is configured per NZP CSI-RS resource set. In this case, if the UE is triggered with an aperiodic trigger state, the UE should assume that all NZP CSI-RS resources associated with the “CSI-AssociatedReportConfigInfo” should be received with a unified TCI state indicated by the TCI state pointer. One benefit with this solution compared to the previous embodiment, is that this solution gives more flexibility, since for example one aperiodic CSI trigger state can be associate with two different “CSI-AssociatedReportConfigInfo” or CSI reports, each associated with one common beam or unified TCI state, which for example could be useful in case the network wants to schedule the UE to measure and report two CSIs associated with two different TRPs (where each TRP is associated with one common beam). An example of configuring a TCI state pointer (or a common beam index) for a CSI-RS resource set associated with an aperiodic CSI trigger state is below.

| | |
|---|---|
| CSI-AssociatedReportConfigInfo ::= | SEQUENCE { |

| | |
|---|---|
| reportConfigId | CSI-ReportConfigId, |
| resourcesForChannel | CHOICE { |
| nzp-CSI-RS | SEQUENCE { |
| resourceSet | INTEGER |

(1..maxNrofNZP-CSI-RS-ResourceSetsPerConfig),

| | |
|---|---|
| qcl-info | SEQUENCE |

(SIZE(1..maxNrofAP-CSI-RS-ResourcesPerSet) ) OF TCI-
StateIdOPTIONAL -- Cond Aperiodic
},

| | |
|---|---|
| csi-SSB-ResourceSet | INTEGER |

(1..maxNrofCSI-SSB-ResourceSetsPerConfig)
},

| | |
|---|---|
| csi-IM-ResourcesFor Interference | INTEGER(1..maxNrofCSI-IM- |

```
ResourceSetsPerConfig)OPTIONAL, -- Cond CSI-IM-ForInterference
  nzp-CSI-RS-ResourcesForInterference INTEGER (1..maxNrofNZP-
CSI-RS-ResourceSetsPerConfig) OPTIONAL, -- Cond NZP-CSI-RS-
ForInterference
  ...
[[
unified-tci-State-Pointer INTEGER (1..maxNrofIndicated-TCI-
States)
]]
}
```

In a further embodiment, a TCI state pointer is explicitly configured per NZP CSI-RS resource by introducing a list of ““Unified-TCI-state-pointer”, as illustrated below. In this case, the UE should assume that the QCL assumption for each NZP CSI-RS resource in the CSI-RS resource set indicated in the aperiodic CSI trigger state is determined according to the associated “unified-TCI-statepointer” configured in the parameter field “follow-unified-tci-State-r18”. For example, if the value of the kth unified-TCI-state-pointer in the list is to 2, then the 2nd indicated unified TCI state applies to the kth NZP CSI-RS resource in the NZP CSI-RS resource set. When “follow-unified-tci-State-r18” is present, the parameter “qcl-info” would be ignored by the UE.

One benefit with this solution compared to the previous embodiment is that this solution gives even more flexibility, since here it is possible to determine the common beam index per NZP CSI-RS resource. This could for example be useful for CSI feedback associated with multiple TRPs, where different NZP CSI-RS resources in a CSI-RS resource set can be associated with different TRPs (and hence different TCI states/common beams).

The next table illustrates an example of configuring a separate TCI state pointer (or a common beam index) for each aperiodic NZP CSI-RS resource in a CSI-RS resource set associated with an aperiodic CSI trigger state.

CSI-AperiodicTriggerStateList information element

-- ASN1START
-- TAG-CSI-APERIODICTRIGGERSTATELIST-START

| | |
|---|---|
| CSI-AperiodicTriggerStateList ::= | SEQUENCE (SIZE |

(1..maxNrOfCSI-AperiodicTriggers) ) OF CSI-AperiodicTriggerState

| | |
|---|---|
| CSI-AperiodicTriggerState ::= | SEQUENCE { |

| | |
|---|---|
| associatedReportConfigInfoList | SEQUENCE |

(SIZE(1..maxNrofReportConfigPerAperiodicTrigger) ) OF CSI-
AssociatedReportConfigInfo,
...
}

| | |
|---|---|
| CSI-AssociatedReportConfigInfo : := | SEQUENCE { |
| reportConfigId | CSI-ReportConfigId, |
| resourcesForChannel | CHOICE { |

| | |
|---|---|
| nzp-CSI-RS | SEQUENCE { |
| resourceSet | INTEGER |

(1..maxNrofNZP-CSI-RS-ResourceSetsPerConfig),

| | |
|---|---|
| qcl-info | SEQUENCE |

(SIZE(1..maxNrofAP-CSI-RS-ResourcesPerSet) ) OF TCI-StateId
OPTIONAL -- Cond Aperiodic

| | |
|---|---|
| follow-unified-tci-State-r18 | SEQUENCE |

```
    (SIZE(1..maxNrofAP-CSI-RS-ResourcesPerSet) ) OF unified-
    TCI-State-Pointer
    },
```

| | |
|---|---|
| csi-SSB-ResourceSet | INTEGER (1..maxNrofCSI- |

SSB-ResourceSetsPerConfig)
},

| | |
|---|---|
| csi-IM-ResourcesFor Interference | INTEGER (1..maxNrofCSI-IM- |

| | |
|---|---|
| ResourceSetsPerConfig) | OPTIONAL, -- Cond CSI-IM- |

ForInterference

| | |
|---|---|
| nzp-CSI-RS-ResourcesForInterference | INTEGER (1..maxNrofNZP- |

| | |
|---|---|
| CSI-RS-ResourceSetsPerConfig) | OPTIONAL, -- Cond NZP-CSI-RS- |

ForInterference
...
}

| | |
|---|---|
| Unified-TCI-State-Pointer ::= | INTEGER |

(1..maxNrofIndicated-TCI-States)
-- TAG-CSI-APERIODICTRIGGERSTATELIST-STOP
-- ASN1STOP

In the above, each TCI state pointer points to a unified TCI state activated and indicated for a BWP in which the CSI-RS is transmitted.

If a UE is activated/indicated with multiple unified TCI states in a BWP and the scheduling offset between the last symbol of a PDCCH carrying the triggering DCI for aperiodic CSI-RS transmission in the same BWP and the first symbol of the aperiodic CSI-RS resources in a NZP CSI-RS resource set is smaller than a UE reported threshold, the UE needs to determine how to receive the aperiodic CSI-RS (e.g., what TCI states or beam(s) for the reception) before decoding the DCI.

In one embodiment, if the triggered aperiodic CSI-RS resource overlaps in an OFDM symbol with another DL signal/channel, the aperiodic CSI-RS is then associated with the same unified TCI state as the other DL signal/channel, wherein the other DL signal/channel can be any one of a periodic CSI-RS, a SP CSI-RS, another aperiodic CSI-RS, or a PDSCH. If there is a PDSCH associated with two unified TCI states in the same symbols as the CSI-RS, the UE applies the first unified TCI state of the two unified TCI states when receiving the aperiodic CSI-RS.

If the triggered aperiodic CSI-RS resource doesn't overlap with any DL signal or channel and if a parameter enableTwoDefaultTCI-States is not configured (i.e., the UE is capable of DL reception with one TCI states before DCI decoding), the UE applies the first indicated unified TCI state. Otherwise, if the UE is configured with a parameter enableTwoDefaultTCI-States (i.e., the UE is capable of DL reception with two TCI states before DCI decoding), the UE applies the first and/or second indicated unified TCI states to the aperiodic CSI-RS reception according to the configured unified TCI state pointer(s) for the aperiodic CSI-RS resources.

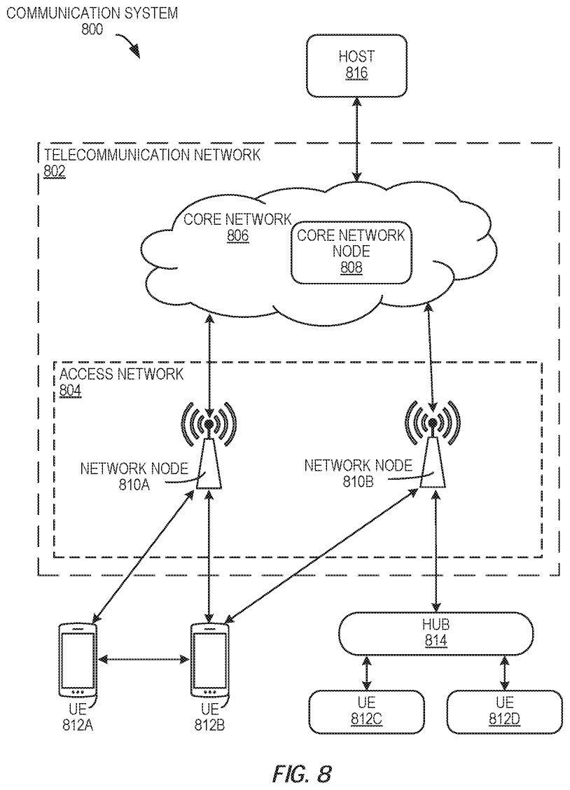

FIG. 8 shows an example of a communication system 800 in accordance with some embodiments.

In the example, the communication system 800 includes a telecommunication network 802 that includes an access network 804, such as a Radio Access Network (RAN), and a core network 806, which includes one or more core network nodes 808. The access network 804 includes one or more access network nodes, such as network nodes 810A and 810B (one or more of which may be generally referred to as network nodes 810), or any other similar Third Generation Partnership Project (3GPP) access node or non-3GPP Access Point (AP). The network nodes 810 facilitate direct or indirect connection of User Equipment (UE), such as by connecting UEs 812A, 812B, 812C, and 812D (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802 and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system 800 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 802 is a cellular network that implements 3GPP standardized features. Accordingly, the telecommunication network 802 may support network slicing to provide different logical networks to different devices that are connected to the telecommunication network 802. For example, the telecommunication network 802 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 814 communicates with the access network 804 to facilitate indirect communication between one or more UEs (e.g., UE 812C and/or 812D) and network nodes (e.g., network node 810B). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a Virtual Reality (VR) headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, if one or more of the UEs are low energy IoT devices.

The hub 814 may have a constant/persistent or intermittent connection to the network node 810B. The hub 814 may also allow for a different communication scheme and/or schedule between the hub 814 and UEs (e.g., UE 812C and/or 812D), and between the hub 814 and the core network 806. In other examples, the hub 814 is connected to the core network 806 and/or one or more UEs via a wired connection. Moreover, the hub 814 may be configured to connect to a Machine-to-Machine (M2M) service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810B. In other embodiments, the hub 814 may be a non-dedicated hub—that is, a device which is capable of operating to route communications between the UEs and the network node 810B, but which is additionally capable of operating as a communication start and/or end point for certain data channels.

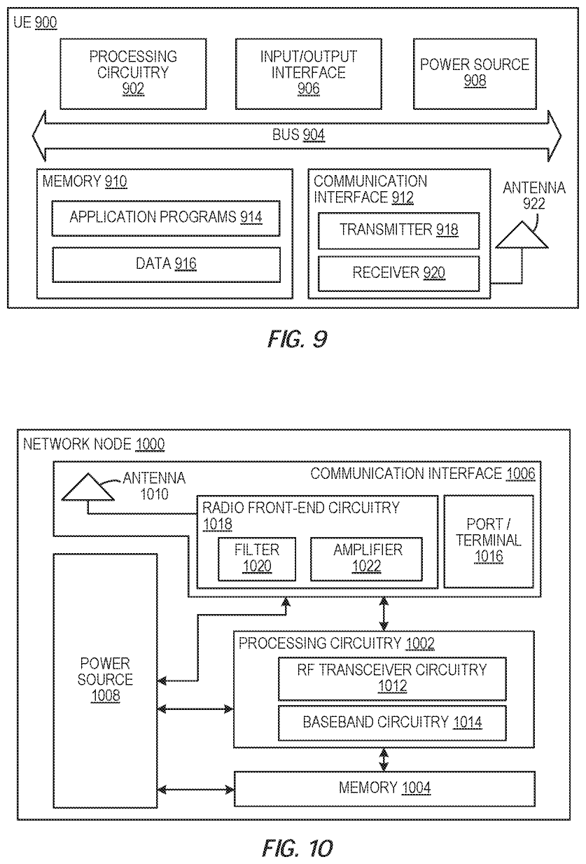

FIG. 9 shows a UE 900 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 902 may include multiple Central Processing Units (CPUs).

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging the power source 908. Power circuitry may perform any formatting, converting, or other modification to the power from the power source 908 to make the power suitable for the respective components of the UE 900 to which power is supplied.

The memory 910 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 910 may allow the UE 900 to access instructions, application programs, and the like stored on transitory or non-transitory memory media, to off-load data, or to upload data. An article of manufacture, such as one utilizing a communication system, may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., the antenna 922) and may share circuit components, software, or firmware, or alternatively be implemented separately.

In the illustrated embodiment, communication functions of the communication interface 912 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 912, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user-initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 900 shown in FIG. 9.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 10 shows a network node 1000 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, memory 1004, a communication interface 1006, and a power source 1008. The network node 1000 may be composed of multiple physically separate components (e.g., a Node B component and an RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1000 may be configured to support multiple RATs. In such embodiments, some components may be duplicated (e.g., separate memory 1004 for different RATs) and some components may be reused (e.g., an antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1000.

The processing circuitry 1002 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1000 components, such as the memory 1004, to provide network node 1000 functionality.

In some embodiments, the processing circuitry 1002 includes a System on a Chip (SOC). In some embodiments, the processing circuitry 1002 includes one or more of Radio Frequency (RF) transceiver circuitry 1012 and baseband processing circuitry 1014. In some embodiments, the RF transceiver circuitry 1012 and the baseband processing circuitry 1014 may be on separate chips (or sets of chips), boards, or units, such as radio units and digital units. In alternative embodiments, part or all of the RF transceiver circuitry 1012 and the baseband processing circuitry 1014 may be on the same chip or set of chips, boards, or units.

The memory 1004 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and the memory 1004 are integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. The radio front-end circuitry 1018 comprises filters 1020 and amplifiers 1022. The radio front-end circuitry 1018 may be connected to the antenna 1010 and the processing circuitry 1002. The radio front-end circuitry 1018 may be configured to condition signals communicated between the antenna 1010 and the processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of the filters 1020 and/or the amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface 1006 may comprise different components and/or different combinations of components.

In certain alternative embodiments, the network node 1000 does not include separate radio front-end circuitry 1018; instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes the one or more ports or terminals 1016, the radio front-end circuitry 1018, and the RF transceiver circuitry 1012 as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, the communication interface 1006, and/or the processing circuitry 1002 may be configured to perform any receiving operations and/or certain obtaining operations described herein as being performed by the network node 1000. Any information, data, and/or signals may be received from a UE, another network node, and/or any other network equipment. Similarly, the antenna 1010, the communication interface 1006, and/or the processing circuitry 1002 may be configured to perform any transmitting operations described herein as being performed by the network node 1000. Any information, data, and/or signals may be transmitted to a UE, another network node, and/or any other network equipment.

The power source 1008 provides power to the various components of the network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid or an electricity outlet) via input circuitry or an interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

FIG. 11 is a block diagram of a host 1100, which may be an embodiment of the host 816 of FIG. 8, in accordance with various aspects described herein. As used herein, the host 1100 may be or comprise various combinations of hardware and/or software including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and memory 1112. Other components may be included in other embodiments. Features of these components may be substantially similar to those described with respect to the devices of previous figures, such as FIGS. 9 and 10, such that the descriptions thereof are generally applicable to the corresponding components of the host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for Over-The-Top (OTT) services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

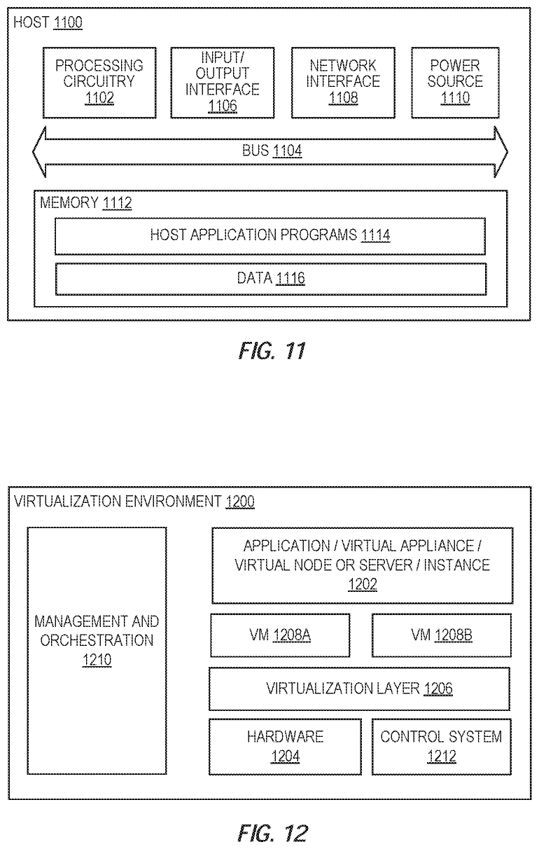

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or VM Monitors (VMMs)), provide VMs 1208A and 1208B (one or more of which may be generally referred to as VMs 1208), and/or perform any of the functions, features, and/or benefits described in relation with some embodiments described herein. The virtualization layer 1206 may present a virtual operating platform that appears like networking hardware to the VMs 1208.

The VMs 1208 comprise virtual processing, virtual memory, virtual networking, or interface and virtual storage, and may be run by a corresponding virtualization layer 1206. Different embodiments of the instance of a virtual appliance 1202 may be implemented on one or more of the VMs 1208, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1208 may be a software implementation of a physical machine that runs programs as if they were executing on a physical, non-virtualized machine. Each of the VMs 1208, and that part of the hardware 1204 that executes that VM, be it hardware dedicated to that VM and/or hardware shared by that VM with others of the VMs 1208, forms separate virtual network elements. Still in the context of NFV, a virtual network function is responsible for handling specific network functions that run in one or more VMs 1208 on top of the hardware 1204 and corresponds to the application 1202.

The hardware 1204 may be implemented in a standalone network node with generic or specific components. The hardware 1204 may implement some functions via virtualization. Alternatively, the hardware 1204 may be part of a larger cluster of hardware (e.g., such as in a data center or CPE) where many hardware nodes work together and are managed via management and orchestration 1210, which, among others, oversees lifecycle management of the applications 1202. In some embodiments, the hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1212 which may alternatively be used for communication between hardware nodes and radio units.

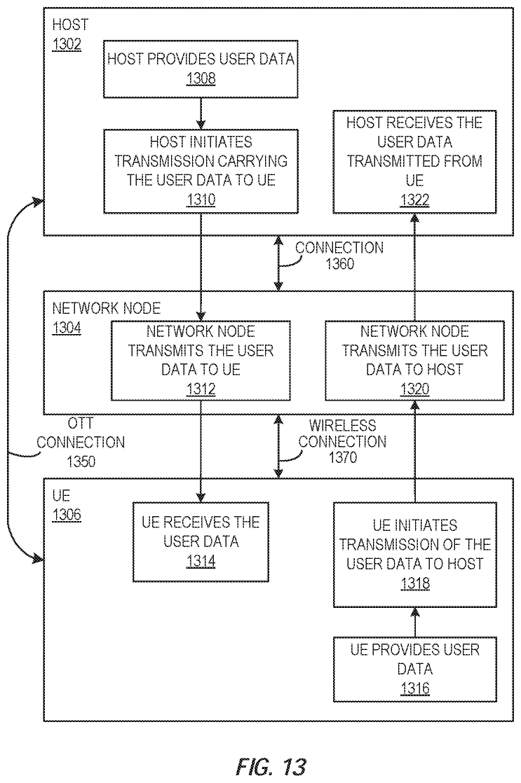

FIG. 13 shows a communication diagram of a host 1302 communicating via a network node 1304 with a UE 1306 over a partially wireless connection in accordance with some embodiments. Example implementations, in accordance with various embodiments, of the UE (such as the UE 812A of FIG. 8 and/or the UE 900 of FIG. 9), the network node (such as the network node 810A of FIG. 8 and/or the network node 1000 of FIG. 10), and the host (such as the host 816 of FIG. 8 and/or the host 1100 of FIG. 11) discussed in the preceding paragraphs will now be described with reference to FIG. 13.

Like the host 1100, embodiments of the host 1302 include hardware, such as a communication interface, processing circuitry, and memory. The host 1302 also includes software, which is stored in or is accessible by the host 1302 and executable by the processing circuitry. The software includes a host application that may be operable to provide a service to a remote user, such as the UE 1306 connecting via an OTT connection 1350 extending between the UE 1306 and the host 1302. In providing the service to the remote user, a host application may provide user data which is transmitted using the OTT connection 1350.

The network node 1304 includes hardware enabling it to communicate with the host 1302 and the UE 1306 via a connection 1360. The connection 1360 may be direct or pass through a core network (like the core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by the UE 1306 and executable by the UE's processing circuitry. The software includes a client application, such as a web browser or operator-specific “app” that may be operable to provide a service to a human or non-human user via the UE 1306 with the support of the host 1302. In the host 1302, an executing host application may communicate with the executing client application via the OTT connection 1350 terminating at the UE 1306 and the host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via the connection 1360 between the host 1302 and the network node 1304 and via a wireless connection 1370 between the network node 1304 and the UE 1306 to provide the connection between the host 1302 and the UE 1306. The connection 1360 and the wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304 in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR, or AR which it can broadcast, multicast, or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1350 between the host 1302 and the UE 1306 in response to variations in the measurement results. The measurement procedure and/or the network functionality for reconfiguring the OTT connection 1350 may be implemented in software and hardware of the host 1302 and/or the UE 1306. In some embodiments, sensors (not shown) may be deployed in or in association with other devices through which the OTT connection 1350 passes; the sensors may participate in the measurement procedure by supplying values of the monitored quantities exemplified above, or by supplying values of other physical quantities from which software may compute or estimate the monitored quantities. The reconfiguring of the OTT connection 1350 may include message format, retransmission settings, preferred routing, etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency, and the like by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionalities described herein may be provided by processing circuitry executing instructions stored in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a user equipment for determining a unified, Transmission Configuration Indication, TCI state, the method comprising one or more of: a. if a single Aperiodic, AP, Channel State Information-Reference Signal, CSI-RS, resource is contained in a Non-Zero Power, NZP, CSI-RS resource set triggered by a Downlink Control Information, DCI: i. If the DCI is carried by a Physical Downlink Control Channel, PDCCH, in a Control Resource Set, CORESET, associated with a Search Space, SS, set which is not linked to any other SS set, the unified TCI state used to receive the PDCCH is used for receiving the AP CSI-RS resource; ii. if the DCI is carried by a PDCCH repeated in two CORESETs each associated with one of two linked SS sets, the unified TCI state used to receive the PDCCH in one of the two CORESETs is used for receiving the AP CSI-RS. The one of two CORESETs can be the CORESET associated with one of the two SS sets having a lower SS set index among the two SS sets; iii. if the DCI is carried by a Single Frequency Network, SFN, PDCCH in a CORESET associated with two unified TCI states, one of the unified TCI states, either the first or second unified TCI state, is used for receiving the AP CSI-RS; b. if two AP CSI-RS resources or groups of AP CSI-RS resources are in a CSI-RS resource set triggered by a DCI, the first and second AP CSI-RS resources or groups of AP CSI-RS resources are associated with the first and second unified TCI states, respectively, where the first and second CSI-RS resources are according to the order configured in the CSI-RS resource set; c. if a single Semi-Persistent, SP, CSI-RS resource in a NZP CSI-RS resource set is activated by a Medium Access Control, MAC, Control Element, CE: i. if the MAC CE is carried by a Physical Downlink Shared Channel, PDSCH, received with a single unified TCI state, the unified TCI sate is also used for receiving the SP CSI-RS resource; ii. if the MAC CE is carried by a PDSCH received with both a first and second, unified TCI states at either the same or different times, one of the two unified TCI states is also used for receiving the SP CSI-RS; d. if two SP CSI-RS resources or two groups of SP CSI-RS resources are in a NZP CSI-RS resource set activated by a MAC CE, the first and second SP CSI-RS resources or groups of SP CSI-RS resources are associated with the first and second unified TCI state, respectively, where the first and second CSI-RS resources are according to the order configured in the CSI-RS resource set; e. if more than two AP or SP CSI-RS resources in a CSI-RS resource set are triggered by a DCI or activated by a MAC CE, the CSI-RS resources are received according to the Quasi Co-location, QCL, information configured or indicated for each of the CSI-RS resources in the corresponding aperiodic CSI trigger state or activation MAC CE.
Embodiment 2: A method performed by a user equipment for determining a unified TCI state, the method comprising one or more of: a. for AP CSI-RS, a unified TCI state pointer may be configured in the associated aperiodic CSI trigger state for the associated CSI-RS resource set or for each NZP CSI-RS resource in the CSI-RS resource set; b. for SP CSI-RS, a unified TCI state pointer may be indicated in the activating MAC CE for each SP CSI-RS resource; c. for periodic CSI-RS, a unified TCI state pointer may be configured in each periodic NZP CSI-RS resource.
Embodiment 3: The method of any of the previous embodiments, further comprising: providing user data; and forwarding the user data to a host via the transmission to the network node.

### Group B Embodiments

Embodiment 4: A method performed by a network node for indicating a unified, Transmission Configuration Indication, TCI state, the method comprising one or more of: a. if a single Aperiodic, AP, Channel State Information-Reference Signal, CSI-RS, resource is contained in a Non-Zero Power, NZP, CSI-RS resource set triggered by a Downlink Control Information, DCI: i. if the DCI is carried by a Physical Downlink Control Channel, PDCCH, in a Control Resource Set, CORESET, associated with a Search Space, SS, set which is not linked to any other SS set, the unified TCI state used to receive the PDCCH is used for receiving the AP CSI-RS resource; ii. if the DCI is carried by a PDCCH repeated in two CORESETs each associated with one of two linked SS sets, the unified TCI state used to receive the PDCCH in one of the two CORESETs is used for receiving the AP CSI-RS. The one of two CORESETs can be the CORESET associated with one of the two SS sets having a lower SS set index among the two SS sets; iii. if the DCI is carried by a Single Frequency Network, SFN, PDCCH in a CORESET associated with two unified TCI states, one of the unified TCI states, either the first or second unified TCI state, is used for receiving the AP CSI-RS; b. if two AP CSI-RS resources or groups of AP CSI-RS resources are in a CSI-RS resource set triggered by a DCI, the first and second AP CSI-RS resources or groups of AP CSI-RS resources are associated with the first and second unified TCI states, respectively, where the first and second CSI-RS resources are according to the order configured in the CSI-RS resource set; c. if a single Semi-Persistent, SP, CSI-RS resource in a NZP CSI-RS resource set is activated by a Medium Access Control, MAC, Control Element, CE: i. if the MAC CE is carried by a Physical Downlink Shared Channel, PDSCH, received with a single unified TCI state, the unified TCI sate is also used for receiving the SP CSI-RS resource; ii. if the MAC CE is carried by a PDSCH received with both a first and second, unified TCI states at either the same or different times, one of the two unified TCI states is also used for receiving the SP CSI-RS; d. if two SP CSI-RS resources or two groups of SP CSI-RS resources are in a NZP CSI-RS resource set activated by a MAC CE, the first and second SP CSI-RS resources or groups of SP CSI-RS resources are associated with the first and second unified TCI state, respectively, where the first and second CSI-RS resources are according to the order configured in the CSI-RS resource set; e. if more than two AP or SP CSI-RS resources in a CSI-RS resource set are triggered by a DCI or activated by a MAC CE, the CSI-RS resources are received according to the Quasi Co-location, QCL, information configured or indicated for each of the CSI-RS resources in the corresponding aperiodic CSI trigger state or activation MAC CE.
Embodiment 5: A method performed by a network node for indicating a unified, Transmission Configuration Indication, TCI state, the method comprising one or more of: a. for AP CSI-RS, a unified TCI state pointer may be configured in the associated aperiodic CSI trigger state for the associated CSI-RS resource set or for each NZP CSI-RS resource in the CSI-RS resource set; b. for SP CSI-RS, a unified TCI state pointer may be indicated in the activating MAC CE for each SP CSI-RS resource; c. for periodic CSI-RS, a unified TCI state pointer may be configured in each periodic NZP CSI-RS resource.
Embodiment 6: The method of any of the previous embodiments, further comprising: obtaining user data; and forwarding the user data to a host or a user equipment.

### Group C Embodiments

Embodiment 7: A user equipment for determining a unified, Transmission Configuration Indication, TCI state, comprising: processing circuitry configured to perform any of the steps of any of the Group A embodiments; and power supply circuitry configured to supply power to the processing circuitry.
Embodiment 8: A network node for indicating a unified, Transmission Configuration Indication, TCI state, the network node comprising: processing circuitry configured to perform any of the steps of any of the Group B embodiments; power supply circuitry configured to supply power to the processing circuitry.
Embodiment 9: A user equipment (UE) for determining a unified, Transmission Configuration Indication, TCI state, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 10: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.
Embodiment 11: The host of the previous embodiment, wherein the cellular network further includes a network node configured to communicate with the UE to transmit the user data to the UE from the host.
Embodiment 12: The host of the previous 2 embodiments, wherein: the processing circuitry of the host is configured to execute a host application, thereby providing the user data; and the host application is configured to interact with a client application executing on the UE, the client application being associated with the host application.
Embodiment 13: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.
Embodiment 14: The method of the previous embodiment, further comprising: at the host, executing a host application associated with a client application executing on the UE to receive the user data from the UE.
Embodiment 15: The method of the previous embodiment, further comprising: at the host, transmitting input data to the client application executing on the UE, the input data being provided by executing the host application, wherein the user data is provided by the client application in response to the input data from the host application.
Embodiment 16: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.
Embodiment 17: The host of the previous embodiment, wherein the cellular network further includes a network node configured to communicate with the UE to transmit the user data from the UE to the host.
Embodiment 18: The host of the previous 2 embodiments, wherein: the processing circuitry of the host is configured to execute a host application, thereby providing the user data; and the host application is configured to interact with a client application executing on the UE, the client application being associated with the host application.
Embodiment 19: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.
Embodiment 20: The method of the previous embodiment, further comprising: at the host, executing a host application associated with a client application executing on the UE to receive the user data from the UE.
Embodiment 21: The method of the previous embodiment, further comprising: at the host, transmitting input data to the client application executing on the UE, the input data being provided by executing the host application, wherein the user data is provided by the client application in response to the input data from the host application.
Embodiment 22: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
Embodiment 23: The host of the previous embodiment, wherein: the processing circuitry of the host is configured to execute a host application that provides the user data; and the UE comprises processing circuitry configured to execute a client application associated with the host application to receive the transmission of user data from the host.
Embodiment 24: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.
Embodiment 25: The method of the previous embodiment, further comprising, at the network node, transmitting the user data provided by the host for the UE.
Embodiment 26: The method of any of the previous 2 embodiments, wherein the user data is provided at the host by executing a host application that interacts with a client application executing on the UE, the client application being associated with the host application.
Embodiment 27: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
Embodiment 28: The communication system of the previous embodiment, further comprising: the network node; and/or the user equipment.
Embodiment 29: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
Embodiment 30: The host of the previous 2 embodiments, wherein: the processing circuitry of the host is configured to execute a host application, thereby providing the user data; and the host application is configured to interact with a client application executing on the UE, the client application being associated with the host application.
Embodiment 31: The host of the any of the previous 2 embodiments, wherein the initiating receipt of the user data comprises requesting the user data.
Embodiment 32: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.
Embodiment 33: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation.
5GC Fifth Generation Core.
5GS Fifth Generation System
AF Application Function
AMF Access and Mobility Function.
AN Access Network
AP Access Point
ASIC Application Specific Integrated Circuit
AUSF Authentication Server Function
CPU Central Processing Unit
DN Data Network
DSP Digital Signal Processor
eNB Enhanced or Evolved Node B
EPS Evolved Packet System
E-UTRA
Evolved Universal Terrestrial Radio Access
Field Programmable Gate Array
FPGA
gNB New Radio Base Station
gNB-DU New Radio Base Station Distributed Unit
HSS Home Subscriber Server
IoT Internet of Things
IP Internet Protocol.
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PC Personal Computer
PCF Policy Control Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function.
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a User Equipment, UE, for determining a unified, Transmission Configuration Indication, TCI state, the method comprising:
receiving a configuration of an aperiodic, AP, channel state information, CSI, trigger state and a configuration of a CSI report associated to the aperiodic CSI trigger state, where the AP CSI trigger state comprising an indication of a first Non-Zero Power CSI reference signal, NZP CSI-RS, resource set in the CSI report configuration;
receiving a first Downlink Control Information, DCI, indicating a first and a second unified TCI states;
receiving a second Downlink Control Information, DCI, indicating the aperiodic CSI trigger state;
determining one of the first and the second unified TCI states based on an RRC configured TCI state pointer in the CSI report configuration; and
receiving CSI-RSs in the first NZP CSI-RS resource set using a spatial filter determined based on the determined unified TCI state.

2. The method of claim 1, where in the TCI state pointer has two logical values, and where the first logical value is indicating the first indicated unified TCI state and the second logical value is indicating the second unified TCI state.

3. The method of claim 1 wherein the second DCI is received a certain time period after the end of the first DCI.

4. The method of claim 1 wherein, a single Aperiodic, AP, CSI-RS resource is contained in the first NZP CSI-RS resource set triggered by the second Downlink Control Information, DCI.

5. The method of claim 2 wherein, if the second DCI is carried by a Physical Downlink Control Channel, PDCCH, in a Control Resource Set, CORESET, associated with a Search Space, SS, set which is not linked to any other SS set, a same unified TCI state used to receive the PDCCH is used for receiving the AP CSI-RS resource, where the unified TCI state is one of the first, and the second unified TCI states.

6. The method of claim 2 wherein, if the second DCI is carried by a PDCCH repeated in two CORESETs each associated with one of two linked SS sets, the unified TCI state used to receive the PDCCH in one of the two CORESETs is used for receiving the AP CSI-RS.

7. The method of claim 2 wherein, the one of two CORESETs can be the CORESET associated with one of the two SS sets having a lower SS set index among the two SS sets.

8. The method of claim 2 wherein, if the second DCI is carried by a Single Frequency Network, SFN, PDCCH in a CORESET associated with two unified TCI states, one of the unified TCI states, either the first or second unified TCI state, is used for receiving the AP CSI-RS.

9. The method of claim 1 wherein, two AP CSI-RS resources or groups of AP CSI-RS resources are contained in the first NZP CSI-RS resource set triggered by the second DCI, the first and second AP CSI-RS resources or groups of AP CSI-RS resources are associated with the first and second unified TCI states, respectively.

10. The method of claim 9 wherein the first and second AP CSI-RS resources are according to the order configured in the first NZP CSI-RS resource set.

11. The method of claim 1 wherein, a single Semi-Persistent, SP, CSI-RS resource in the first NZP CSI-RS resource set is activated by a Medium Access Control, MAC, Control Element, CE.

12. The method of claim 11 wherein, if the MAC CE is carried by a Physical Downlink Shared Channel, PDSCH, received with a single unified TCI state, the single unified TCI sate is also used for receiving the SP CSI-RS resource, wherein the single unified TCI state is one of the first and second unified TCI states.

13. The method of claim 11 wherein, if the MAC CE is carried by a PDSCH received with both the first and the second unified TCI states at either the same or different times, one of the first and the second unified TCI states is also used for receiving the SP CSI-RS.

14. The method of claim 1 wherein, two SP CSI-RS resources or two groups of SP CSI-RS resources are contained in the first NZP CSI-RS resource set activated by a MAC CE, the first and second SP CSI-RS resources or groups of SP CSI-RS resources are associated with the first and second unified TCI states, respectively.

15. The method of claim 14 wherein the first and second SP CSI-RS resources are according to the order configured in the first NZP CSI-RS resource set.

16. The method of claim 1 wherein, more than two AP or SP CSI-RS resources in the first NZP CSI-RS resource set are triggered by the second DCI or activated by a MAC CE, the CSI-RS resources are received according to Quasi Co-location, QCL, information configured or indicated for each of the CSI-RS resources in the aperiodic CSI trigger state or activation MAC CE.

17. The method of claim 1 wherein, for AP CSI-RS, a unified TCI state pointer is configured in the aperiodic CSI trigger state for the first NZP CSI-RS resource set or for each NZP CSI-RS resource in the first NZP CSI-RS resource set.

18. The method of claim 1 wherein, for SP CSI-RS, a unified TCI state pointer is indicated in the activating MAC CE for each SP CSI-RS resource.

19. The method of claim 1 wherein, for periodic CSI-RS, a unified TCI state pointer is configured in each periodic NZP CSI-RS resource.

20. The method of claim 16, wherein the unified TCI state pointer indicates which one of the first, the second, and the third unified TCI states is to be used for receiving the CSI-RS in each NZP CSI-RS resource in the first NZP CSI-RS resource set, wherein the third unified TCI state is a unified TCI state indicated in the QCL information configured in the aperiodic CSI trigger state.

21. A method performed by a network node for indicating a unified, Transmission Configuration Indication, TCI state, the method comprising:
transmitting a configuration of an aperiodic, AP, channel state information, CSI, trigger state and a configuration of a CSI report associated to the aperiodic CSI trigger state, where the AP CSI trigger state comprising an indication of a first Non-Zero Power CSI reference signal, NZP CSI-RS, resource set in the CSI report configuration;
transmitting a first Downlink Control Information, DCI, indicating a first and a second unified TCI states;
transmitting a second Downlink Control Information, DCI, indicating the aperiodic CSI trigger state, where the second DCI is transmitted a certain time period after the end of the first DCI; and
transmitting one or more CSI-RS resource in the first NZP CSI-RS resource set using one of the first, the second, and a third unified TCI state.

22. The method of claim 21 wherein, a single Aperiodic, AP, CSI-RS resource is contained in the first NZP CSI-RS resource set triggered by the second Downlink Control Information, DCI.

23. The method of claim 22 wherein, if the second DCI is carried by a Physical Downlink Control Channel, PDCCH, in a Control Resource Set, CORESET, associated with a Search Space, SS, set which is not linked to any other SS set, a same unified TCI state used to transmit the PDCCH is used for transmitting the AP CSI-RS resource, where the unified TCI state is one of the first, the second, and a third unified TCI states.

24. The method of claim 22 wherein, if the second DCI is carried by a PDCCH repeated in two CORESETs each associated with one of two linked SS sets, the unified TCI state used to transmit the PDCCH in one of the two CORESETs is used for transmitting the AP CSI-RS.

25-38. (canceled)

39. A User Equipment, UE, for determining a unified, Transmission Configuration Indication, TCI state, comprising:
processing circuitry configured to perform the steps of:
receive a configuration of an aperiodic, AP, channel state information, CSI, trigger state and a configuration of a CSI report associated to the aperiodic CSI trigger state, where the AP CSI trigger state comprising an indication of a first Non-Zero Power CSI reference signal, NZP CSI-RS, resource set in the CSI report configuration;
receive a first Downlink Control Information, DCI, indicating a first and a second unified TCI states;
receive a second Downlink Control Information, DCI, indicating the aperiodic CSI trigger state;
determine one of the first and the second unified TCI states based on an RRC configured TCI state pointer in the CSI report configuration; and
receive CSI-RSs in the first NZP CSI-RS resource set using a spatial filter determined based on the determined unified TCI state.

40. (canceled)

41. A network node, for indicating a unified, Transmission Configuration Indication, TCI state, comprising:
processing circuitry configured to:
transmit a configuration of an aperiodic, AP, channel state information, CSI, trigger state and a configuration of a CSI report associated to the aperiodic CSI trigger state, where the AP CSI trigger state comprising an indication of a first Non-Zero Power CSI reference signal, NZP CSI-RS, resource set in the CSI report configuration;
transmit a first Downlink Control Information, DCI, indicating a first and a second unified TCI states;
transmit a second Downlink Control Information, DCI, indicating the aperiodic CSI trigger state, where the second DCI is transmitted a certain time period after the end of the first DCI; and
transmit one or more CSI-RS resource in the first NZP CSI-RS resource set using one of the first, the second, and a third unified TCI state.

42. (canceled)
